(19) United States
(12) Patent Application Publication
(10) Pub. No.: US 2015/0185068 A1
(43) Pub. Date: Jul. 2, 2015

(54) INVENTORY CONTROL SYSTEMS AND METHODS

(71) Applicant: CAPTURETECH CORPORATION B.V., Nieuw Vennep (NL)

(72) Inventors: Maarten A. ANDERSON, Haarlem (NL); Gerben HILLEBRAND, Alphen aan den Rijn (NL); Marinus J.M. BIERBOOMS, Utrecht (NL)

(21) Appl. No.: 14/143,954

(22) Filed: Dec. 30, 2013

(51) Int. Cl. G01G 19/40; G01G 21/02; B65D 81/02; G06K 7/10; B65D 25/22; G06Q 10/08; G01G 19/14

(52) U.S. Cl. CPC G01G 19/40; G06Q 10/087; G01G 21/02; G01G 19/14; G06K 7/10366; B65D 25/22; B65D 81/02

(57) ABSTRACT

Disclosed are methods, systems, apparatus, devices, products, media and other implementations, including a system that includes a weight measure device with a suspension member, a wireless communication module, and a controller. The controller is configured to cause measuring a combined weight of one or more items suspended from the suspension member at a first time instance, with each of the one or more items including a respective traceable object coupled to a respective wireless identification device, and obtaining information transmitted to the wireless communication module by the respective wireless identification devices representative of an identification associated with the respective wireless identification device and the respective traceable object. The controller is also configured to cause obtaining from a database individual weights for each of the items, and determining whether the combined weight matches a sum of the individual weights obtained from the database for the one or more items.

### BACKGROUND

Business operations that involve the distribution and use of numerous inventory items (e.g., keys) require careful inventory control of such items, including the issuance (i.e., check-out), registration, and subsequent collection (i.e., return) of those inventory items. Such inventory control operations are time and resource consuming, and are prone to errors. Some situations requiring effective and secure inventory control include: 1) issuing route keys to crews that service ATMs, banks, retail outlets and other facilities, with some routes requiring a large number of stops, 2) issuing fire arms, 3) issuing internal keys to branch doors and lockers, or 4) issuing other assets such as communication devices, hand-held scanners, and other assets. In these types of situations, accurately registering the items checked out and ascertaining that all such items are properly returned can be challenging.

### SUMMARY

In some variations, a system is disclosed. The system includes a weight measure device with a suspension member, a wireless communication module, and a controller. The controller is configured to cause, when operating, operations including measuring a combined weight of one or more items suspended from the suspension member of the weight measure device at a first time instance, with each of the one or more items including a respective traceable object coupled to a respective wireless identification device, and obtaining information transmitted to the wireless communication module by the respective wireless identification device of the each of the one or more items suspended from the suspension member of the weight measure device at the first time instance, the information being representative of an identification associated with the respective wireless identification device and the respective traceable object. The controller is also configured to cause operations including obtaining from a database in electrical communication with the controller, based on the information transmitted by the respective wireless identification device of the each of the one or more items, individual weights for each of the one or more items suspended from the suspension member, and determining whether the combined weight of the one or more items suspended from the suspension member of the weight measure device at the first time instance matches a sum of the individual weights obtained from the database for the one or more items.

Embodiments of the system may include at least some of the features described in the present disclosure, including one or more of the following features.

The controller may further be configured to cause further operations including measuring weight of a returned set of items suspended from the suspension member of the weight measure device at a second time instance subsequent to the first time instance, obtaining identification information transmitted from at least one returned wireless identification device included with the returned set of items suspended from the suspension member of the weight measure device at the second time instance, obtaining from the database, based on the information transmitted by the at least one returned wireless identification device included with the returned set of items, individual weights for each returned item in the returned set of items suspended from the suspension member, and determining whether the combined weight of the returned set of items measured at the second time instance matches a sum of the individual weights obtained from the database for the each returned item in the returned set of items.

The controller may further be configured to cause further operations including determining whether the combined weight of the returned set of items measured at the second time instance matches the combined weight of the one or more items measured at the first time instance, and whether the identification information obtained from the at least one returned wireless identification device at the second time instance matches the information transmitted by the respective wireless identification device of the each of the one or more items at the first time instance.

The weight measure device and the wireless communication module may be housed in a cabinet.

The wireless communication module may be housed in a detachable L-shaped cartridge that can be fitted into a cavity defined in an inner wall of the cabinet.

The cabinet may include internal walls constructed from a radiation-impervious material to prevent transmission of wireless signals originating within the cabinet from exiting the cabinet.

The respective wireless identification device of the each of the one or more items may include an RFID device.

The suspension member of the weight measure device may include a hook.

The respective traceable object of the each of the one or more items may include a key, and one or more keys may be configured to be suspended from the hook.

The system may further include a basket suspended from the suspension member, with the basket configured to receive items for weight measurement and identification processing.

The respective traceable object of the each of the one or more items may include one or more of, for example, a key, a fire arm, ammunition, and/or a portable a communication device.

The controller may further be configured to cause further operations including controlling one or more of a data rate or transmission power of the communication control module.

Determining whether the combined weight of the one or more items suspended from the suspension member of the weight measure device at the first time instance matches the sum of the individual weights obtained from the database for the one or more items may include determining whether a difference between the combined weight of the one or more items suspended from the suspension member of the weight measure device at the first time instance and the sum of the individual weights obtained from the database for the one or more items is less than or equal to a pre-determined weight tolerance value.

The controller may further be configured to cause further operations including setting the pre-determined weight tolerance value based on input from a user.

The controller may further be configured to cause further operations including determining based on identification information obtained from one or more wireless identification devices whether one or more objects associated with the identification information obtained from the one or more wireless identification devices are to be checked-out or are being returned, and identifying a route associated with the one or more objects.

In some variations, a method is provided. The method includes measuring a combined weight of one or more items suspended from a suspension member of a weight measure device at a first time instance, with each of the one or more items including a respective traceable object coupled to a respective wireless identification device, and obtaining information transmitted to a wireless communication module by the respective wireless identification device of the each of the one or more items suspended from the suspension member of the weight measure device at the first time instance, the information being representative of an identification associated with the respective wireless identification device and the respective traceable object. The method further includes obtaining from a database, based on the information transmitted by the respective wireless identification device of the each of the one or more items, individual weights for each of the one or more items suspended from the suspension member, and determining whether the combined weight of the one or more items suspended from the suspension member of the weight measure device at the first time instance matches a sum of the individual weights obtained from the database for the one or more items.

Embodiments of the method may include at least some of the features described in the present disclosure, including at least some of the features described above in relation to the system.

In some variations, an apparatus is provided. The apparatus includes means for measuring a combined weight of one or more items suspended from a suspension member of a weight measure device at a first time instance, with each of the one or more items including a respective traceable object coupled to a respective wireless identification device, and means for obtaining information transmitted to a wireless communication module by the respective wireless identification device of the each of the one or more items suspended from the suspension member of the weight measure device at the first time instance, the information being representative of an identification associated with the respective wireless identification device and the respective traceable object. The apparatus also includes means for obtaining from a database, based on the information transmitted by the respective wireless identification device of the each of the one or more items, individual weights for each of the one or more items suspended from the suspension member, and means for determining whether the combined weight of the one or more items suspended from the suspension member of the weight measure device at the first time instance matches a sum of the individual weights obtained from the database for the one or more items.

Embodiments of the apparatus may include at least some of the features described in the present disclosure, including at least some of the features described above in relation to the system, and the method.

In some variations, a non-transitory computer readable media is provided. The computer readable media is programmed with a set of instructions executable on a processor that, when executed, causes operations including measuring a combined weight of one or more items suspended from a suspension member of a weight measure device at a first time instance, with each of the one or more items including a respective traceable object coupled to a respective wireless identification device, and obtaining information transmitted to a wireless communication module by the respective wireless identification device of the each of the one or more items suspended from the suspension member of the weight measure device at the first time instance, the information being representative of an identification associated with the respective wireless identification device and the respective traceable object. The set of instructions also causes operations including obtaining from a database, based on the information transmitted by the respective wireless identification device of the each of the one or more items, individual weights for each of the one or more items suspended from the suspension member, and determining whether the combined weight of the one or more items suspended from the suspension member of the weight measure device at the first time instance matches a sum of the individual weights obtained from the database for the one or more items.

Embodiments of the computer readable media may include at least some of the features described in the present disclosure, including at least some of the features described above in relation to the system, the method, and the apparatus.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “or” or “and” as used in a list of items prefaced by “at least one of” or “one or more of” indicates that any combination of the listed items may be used. For example, a list of “at least one of A, B, or C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, or C” (or “one or more of A, B, or C”) may also include A, AA, AAB, AAA, BB, BCC, etc.

As used herein, including in the claims, unless otherwise stated, a statement that a function, operation, or feature, is “based on” an item and/or condition means that the function, operation, function is based on the stated item and/or condition and may be based on one or more items and/or conditions in addition to the stated item and/or condition.

Details of one or more implementations are set forth in the accompanying drawings and in the description below. Further features, aspects, and advantages will become apparent from the description, the drawings, and the claims.

### BRIEF DESCRIPTION OF THE DRAWINGS

FIG. 1 is a diagram of an example system implementation to track and manage inventories and items.

FIG. 2 is a flowchart of an example procedure to track and manage items.

FIGS. 3A-C are example screenshots of graphical user interfaces (GUI's) through which information about users, locations, and routes can be entered.

FIGS. 4A and 4B are example screenshots of GUI's for providing item information.

FIGS. 5A-B are example screenshots of an item-checkout summary and an outbound receipt to be signed or confirmed by a user taking possession of items.

FIGS. 6A-B are example screenshots of an inbound items returned summary, and of an inbound receipt confirming that items previously checked out have been returned.

FIG. 7 is a diagram of an example cabinet-like housing in which items to be tracked or managed are placed, and a modular L-shaped cartridge that houses a communication module and/or other electronic circuitry.

FIG. 8 is a schematic diagram of a generic computing system.

Like reference symbols in the various drawings indicate like elements.

### DETAILED DESCRIPTION

Disclosed herein are systems, devices, apparatus, methods, computer program products, media and other implementations, including a system that includes a weight measure device with a suspension member with which inventory items to be managed can be weighed at substantially a single weight point, a wireless communication module configured to communicate with wireless identification devices associated with the items to be managed, and a controller (e.g., a processor-based controller). The controller is configured, when operating, to cause operations that include measuring a combined weight of one or more items suspended from the suspension member of the weight measure device at a first time instance, with each of the one or more items including a respective traceable object (e.g., keys, fire arms, or other items that need to be tracked and/or managed) coupled to a respective wireless identification device (e.g., a passive wireless device, such as an RFID device, a powered wireless transceiver configured to receive and transmit wireless communications, etc.), and obtaining information transmitted to the wireless communication module by the respective wireless identification device of the each of the one or more items suspended from the weight measure device at the first time instance, with the information being representative of an identification associated with the respective wireless identification device and the respective traceable object. The controller is further configured to cause the operations of obtaining from a database in electrical communication with the controller, based on the information transmitted by the respective wireless identification device of the each of the one or more items, individual weights for each of the one or more items suspended from the suspension member, and determining whether the combined weight of the one or more items suspended from the suspension member of the weight measure device at the first time instance matches a sum of the individual weights obtained from the database for the one or more items. If the combined measured weight and the weight sum (determined based on previously recorded individual weights for the items being tracked managed) match, the checkout procedure may proceed. Otherwise, there may be a problem with the items that are to be checked out, and some remedial action (e.g., a visual inspection) may be required.

In some embodiments, a similar procedure may be followed upon items being returned. Thus, in such embodiments, a returned set of items is suspended from a suspension member of a weight measure device to measure its combined weight, the identity of the items included in the returned set is obtained (based on information transmitted by the wireless identification devices included with the returned set), and the measured combined weight is checked against a sum of individual weights for the returned items obtained from the database according to the identification information provided by the wireless identification devices in the returned set (e.g., the identification values are used to access records on the database). In some embodiments, the combined weight measured at inbound and outbound may be compared (to check if there are any discrepancies), and the identification information provided by the wireless identification devices at inbound and outbound may also be compared (e.g., as another way of ensuring that items that were checked out have been returned).

The systems, methods, and other implementations described herein can thus determine efficiently and quickly whether there is a weight discrepancy between an expected sum of weights for items being checked in or out, and the combined measured weight of the items. A weight discrepancy may indicate that an item is missing (e.g., even if its associated wireless identification device may be communicating/interacting with the communication module of the system), that one of the items is broken (thus requiring a visual inspection of the items to identify the broken item), etc.

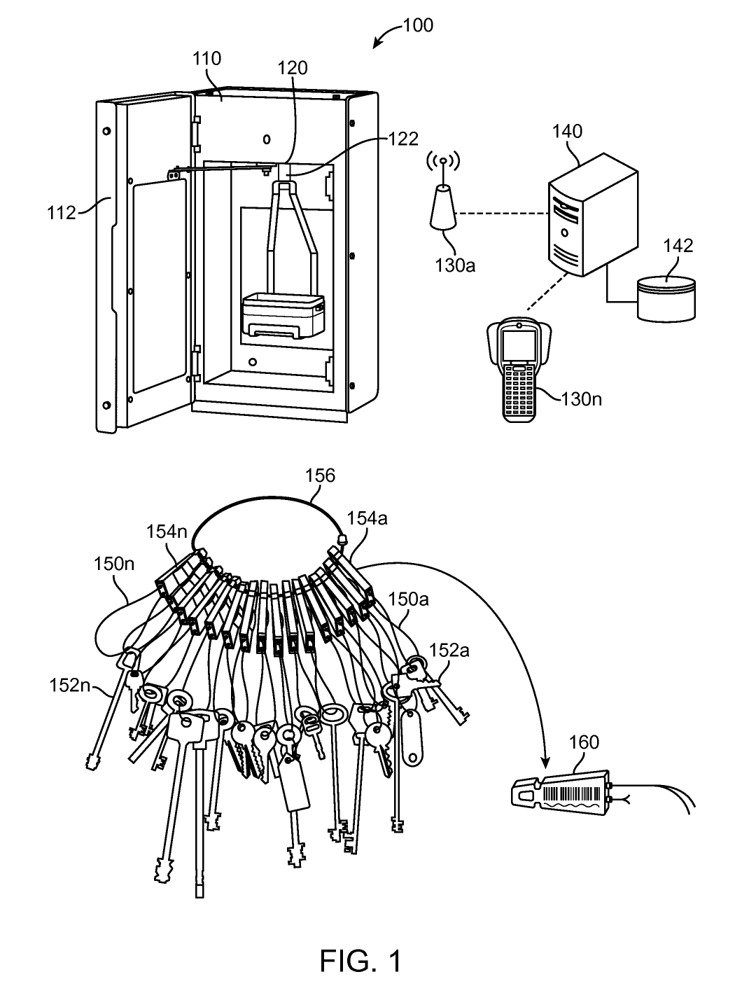

Thus, with reference to FIG. 1, a diagram of an example system implementation 100 to track and manage inventory items is shown. The system 100 includes a housing 110 (e.g., a cabinet like housing) to receive one or more items that are to be tracked. Disposed in the housing 110 is a weight measure device 120 (e.g., a weight scale, such as an electronic weight scale device) that includes a suspension member 122 from which the items to be weighed can be suspended (i.e., the suspended weight pulls down on the suspension member). The use of a suspension member for weight measuring enables placing the items to be measured at a single weighing point, which may provide more accurate weight measuring than can be achieved with weight measure devices such as platform-based weight measure devices that rely on exertion of a downward force (i.e., a pushing force) in order to measure the weight.

The housing 110 includes a door 112 that can be closed to isolate the interior of the housing (in which the suspension member 122 of the weight measure device 120 is disposed) from the outside. The housing 110 (including the door 112) may be constructed from radiation impervious materials (e.g., conductive and/or magnetic materials, such as stainless steel or other types of metal/alloys) so that when the door 112 is closed, the interior of the housing is shielded from outside electromagnetic radiation. Thus, with the door 112 closed, a communication module disposed, for example, within the housing 110 will be able to communicate only with wireless identification devices (attached to the objects to be tracked and managed) that are located within the housing 110 without transmitting communication signals to, or receiving communication signals from, wireless devices (such as RDIF tags) that are outside the housing and with which the communication module is not supposed to interact at that particular time instance.

The system 100 further includes one or more wireless communication modules 130a-n configured to communicate with wireless identification devices (e.g., RFID) associated with the items to be tracked. Each of the communication modules 130a-n is configured to, in some embodiments, transmit a trigger/interrogation signal that is received by the wireless identification devices associated with the one or more items that are to be tracked and managed. In some embodiments, a communication module transmits the trigger signal in response to detecting that the items to be identified have been presented for weighing (e.g., when the suspension member 122 of the weight measure device is pulled downward by the weight of the items to be tracked). In some embodiments, the trigger signal may be sent by the communication module in response to a user request, as a result of periodic transmissions of a trigger signal, based on an initiating signal transmitted from a device associated with the one or more items to be tracked and managed (e.g., in embodiments in which an active wireless device may be bundled with the items to be tracked, with such an active wireless device configured to transmit beacons indicating the presence of one or more items that are to be tracked so as to cause the wireless communication module, upon detection of such a beacon, to transmit trigger signals to the wireless identification devices). Upon receiving the trigger signal, the wireless identification devices associated with traceable objects (e.g., keys) of the items to be tracked and managed are configured to each transmit a reply/answer signal that includes information representative of an identification associated with the respective wireless identification device and the respective traceable object.

The wireless communication module 130 may be configured to communicate with wireless identification devices using one or more types of wireless technologies, including communicating with wireless communication devices implemented as active or passive devices (i.e., devices with a power supply). In some embodiments, the wireless communication devices may be implemented using UHF RFID devices. In some embodiments, the wireless identifications devices may implement, for example, communication protocols such as Bluetooth® wireless technology, Ultra-Wideband (UWB), and/or other types of near field or long range wireless communication technologies. Furthermore, communication between the wireless communication module and the wireless identification devices may not necessarily be limited to radio frequency (RF) communication, but may include various other forms of wireless communication, such as infrared (IR) communication, for example. The wireless communication module may be configured to adjust the transmission power and/or the data rate of signals transmitted by it or by the devices with which it communicates.

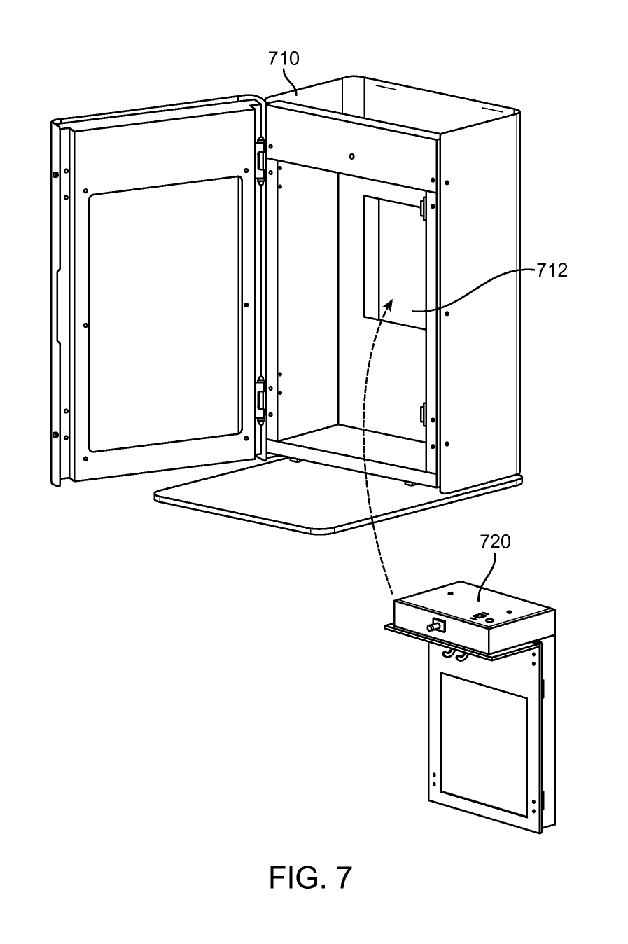

As shown in FIG. 1, the wireless communication module used may be a stationary or a portable wireless communication module. For example, in some embodiments, a stationary wireless communication module, such as the wireless communication module 130a (which may be disposed inside or outside of the housing 110) may be used to communicate with the wireless identification device(s) associated with the objects to be traced. In some embodiments, the wireless communication module may be housed in a modular cartridge that can be fitted within a complementary receiving cavity to enable easy removal of the cartridge when needed (e.g., for repair, when a communication module implementing a different communication protocol needs to be used, etc.) Thus, with reference to FIG. 7, an example cabinet-like housing 710, in which items to be tracked or managed are placed, and a modular L-shaped cartridge 720 that houses a communication module (and/or other electronic circuitry) is shown. The housing 710 includes a cavity 712 into which the cartridge 720 can be fitted. A suspension member (not shown in FIG. 7) may be attached to a cavity/aperture 722 at the top of the cartridge 720. In some embodiments, the cartridge 720 may also house the entire weight measure device.

Additionally, and/or alternatively, a portable communication module, such as the portable module 130n may be used. In some embodiments, both the wireless communications modules 130a and 130n may be used, with the portable wireless communication module being used to perform periodical location-wide inventory checks of all the assets/objects at a particular location (e.g., to maintain up-to-date records of all available assets/items of the inventory), while the stationary wireless communication module may be used primarily to communicate with the wireless identification devices associated with objects that are being checked-in or returned (e.g., the stationary wireless communication module may thus be activated in response to some triggering event, such as the pulling down of the suspension member of the weight measure device).

Electrically coupled to the one or more wireless communication modules 130a-n is a computing system 140 configured to perform (alone, or in combination with other remote servers/computing systems) the processes and operations to track and perform inventory management with respect to one or more items. For example, the system 140 may be configured to maintain/manage a database 142 (in electrical communication with the system 140) recording traceable objects (e.g., keys, fire arms, ammunition, portable/personal communication devices, etc.) that are to be tracked, along with associated identification information corresponding to wireless identification devices that are associated with the traceable objects. An example of a database application that may be used/implemented on the computing system 140 is an SQL-based database system such as the SQL server 2008 R2 express (which may comprise part of the computing system 140). The computing system 140 may also be configured to control/adjust the transmission power at which the wireless communication module 130a and/or 130n are to operate, and/or to control/adjust the data rate at which the wireless communication modules are to communicate with, for example, the wireless identification devices associated with the items to be tracked and managed.

As noted, and as will be further discussed in greater details below, the system 140 is configured, for example, to obtain, via the wireless communication module 130a (and/or 130n), the identification information transmitted from the wireless identification devices (associated with the traceable objects) in response to a trigger signal sent by the communication module 130a. The system 140 is also configured to obtain weight measurement values for the objects that are to be traced, as well as other germane auxiliary information such as route information, identity of the person(s) that is to take possession of the objects to be traced, etc. The auxiliary information may be entered via a user interface coupled to the system 140 (e.g., a keyboard, a touch pad, etc.), via scannable media (e.g., a magnetic card carried by the person taking possession of the objects), etc. The computing system 140 is also configured to obtain information about returned objects (e.g., their weight and identification information associated with them). The identification information provided to the computing system 140 (e.g., at outbound, inbound, or both) may be used to access records on the database implemented (or coupled to) the computing system 140 in order to retrieve or otherwise obtain weight information for the items associated with the identification information transmitted from the wireless identification devices, and to compare the combined measured weight information to an expected weight sum for the items to be tracked. If there is a discrepancy in the weights, a remedial action may be taken (e.g., an alert may be issued by the computing system 140, requiring an administrator to conduct a visual inspection of the items being checked-out or returned). In some implementations, the computing system 140 may also be configured to compare information stored on the server at the time the items being tracked were checked out to information obtained upon return of the items. For example, the computing system 140 may compare the combined weights at the points of check-out and return, and also compare the identification information received from the wireless identification devices at those two time instance, and determine if there's a discrepancy between the compared values, and whether an appropriate action needs to be performed (e.g., issue an appropriate alert advising of any discrepancy between the “checked-out” and “returned” information). The system 140 may also be configured to wirelessly communicate with the wireless communication module(s) (e.g., in situations where a portable wireless communication module, such as the communication module 130n, is used), and as such the system 140 may include one or more wireless transceivers to enable such wireless communication.

In some embodiments, the computing system 140 may be configured to determine whether items for which it obtained identification information are being checked out or are being returned (e.g., when it is determined that the items for which identification information is obtained are indicated by the database to be checked-out). Thus, in such embodiments, the computing system 140 is configured to cause operations including determining based on identification information obtained from one or more wireless identification devices whether one or more objects associated with the identification information obtained from the one or more wireless identification devices are to be checked-out or are being returned. In some embodiments, the wireless communication module (such as the module 130a) may be incorporated within the server 140.

FIG. 1 further shows an example of one or more items 150a-n that are tracked and managed by the system 100. Each of the one or more items 150a-n includes a respective one of traceable objects 152a-n (e.g., in the example of FIG. 1, the traceable objects are keys, but any type of item, including personal fire arms, personal communication devices, etc., may be used) that is coupled, e.g., via a coupling member or mechanism such as a chain, a wire, or some other coupler type, to a respective one of wireless identification devices 154a-n. As noted, in some embodiments, at least one of the wireless identification devices 154a-n may be a passive wireless identification device, such as an RFID device, e.g., a UHF RFID tag, comprising a microchip with an antenna, configured to utilize the energy of an incoming trigger signal from a wireless communication module to transmit a reply signal that includes identification information associated with the particular wireless identification device transmitting the reply signal (and thus associated with the traceable object coupled to the particular wireless identification device). In some embodiments, the wireless identification devices employed are RFID-enabled seals (such as the KeyCop™, manufactured by CaptureTech, shown in greater detail as the device 160 of FIG. 1) to which the traceable objects (e.g., keys) are attached. Once attached, the traceable objects cannot be taken off the seal unless the wire is cut. A wireless identification device, such as the KeyCop™ device, may be available in multiple pairs of colors and can be laser engraved with any text, logo or barcode, and contain a standard Ultra High Frequency (UHF) RFID tag in which information, such as a specific identification number, can be stored. This allows the number of the seal to be retrieved in one of three different ways: by reading a non-coded number on the seal, by scanning a barcode, or by reading the RFID tag. In some embodiments, the wireless identification devices may include RFID labels, or RFID inlays, that are placed on the traceable objects (e.g., in situations involving traceable objects such as fire arms, where the use of a tag-based or seal-based wireless identification devices may hinder use of the traceable objects to be tracked).

In situations where the items 150a-n include keys coupled to the respective wireless identification devices 154a-n, the keys may be placed on a key ring 156 that can be suspended from the suspension member 122, or be placed in a basket/tray suspended from the suspension member, in order to be weighed by the weight measure device and/or have the identification information associated with the objects 152a-n (namely the keys) transmitted to the one or more of the communication modules 130a-n. In some embodiments, the weighing and the transmission of identification information may commence (substantially concurrently) in response to a triggering event or occurrence (e.g., the lowering of the suspension member 122, the closing of the door 112, or some other event/occurrence).

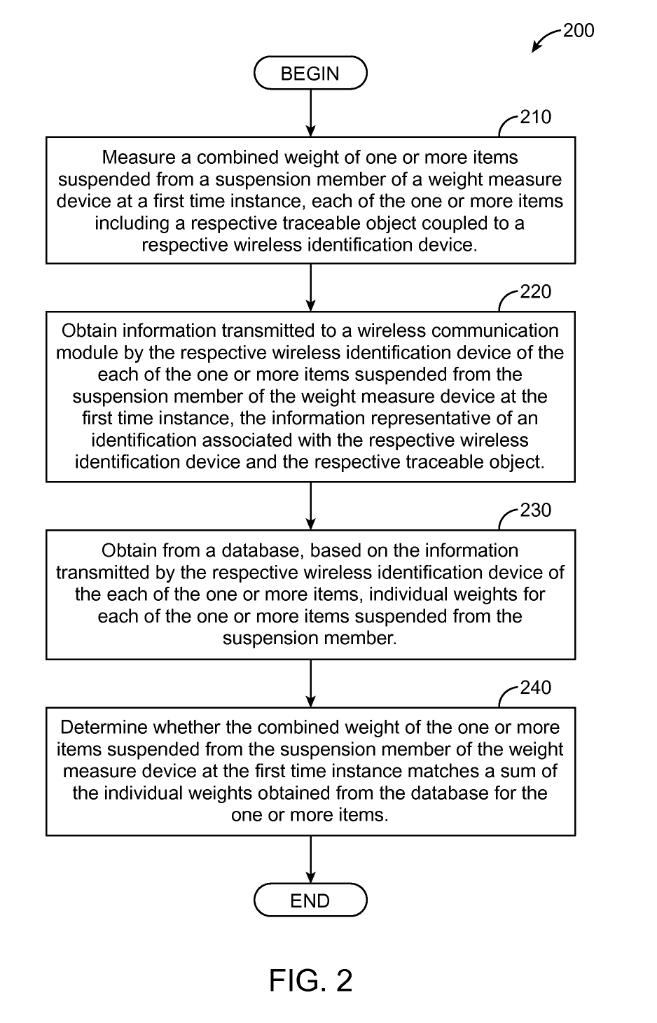

With reference now to FIG. 2, a flowchart of an example procedure 200 to track and manage inventory items is shown. The procedure 200 includes measuring 210 a combined weight of one or more items suspended from a suspension member of a weight measure device (e.g., such as the suspension member 122 of the weight measure device 120) at a first time instance. Each of the one or more items includes a respective traceable object (such as a key, a fire arm, ammunition, a mobile device, or any other object that needs to be accurately tracked and inventory managed) that is coupled to a respective wireless identification device such as, for example, an RFID tag (passive or active RFID tag), or some other device configured for near field communication or long range wireless communication. In some implementations, the items may be placed in a receptacle/tray that is suspended from the suspension member.

At substantially the same time that the weight of the one or more items is measured, information transmitted to a wireless communication module by the respective wireless identification device of the each of the one or more items suspended from the suspension member of the weight measure device is obtained 220, with that information being representative of an identification associated with the respective wireless identification device and the respective traceable object. The identification information received from the wireless identification devices may be recorded on the wireless identification devices (e.g., written, by, for example, a communication module such as the module 130a and/or 130n, to memory storage provided with microchips of the wireless communication devices).

As noted, in some embodiments, the operations to measure the combined weight of the items to be tracked and to obtain the information representative of the identification associated with the items may be initiated by a triggering event or occurrence, for example, the closing of the door of a cabinet-like housing in which the weight measure device is disposed, the lowering of the suspension member of the weight measure device (as a result of suspending the items from the suspension bar), etc. The triggering event may cause the communication module to transmit a trigger/interrogation signal that is received by the wireless identification devices of the items to be tracked. In some implementations, the communication module (or at least its antenna) is housed within the housing containing the weight measure device. Where the housing is constructed from a radiation impervious material (and when the door of the housing is closed), the trigger signal from the communication module will generally be received only by the wireless identification devices placed inside the housing.

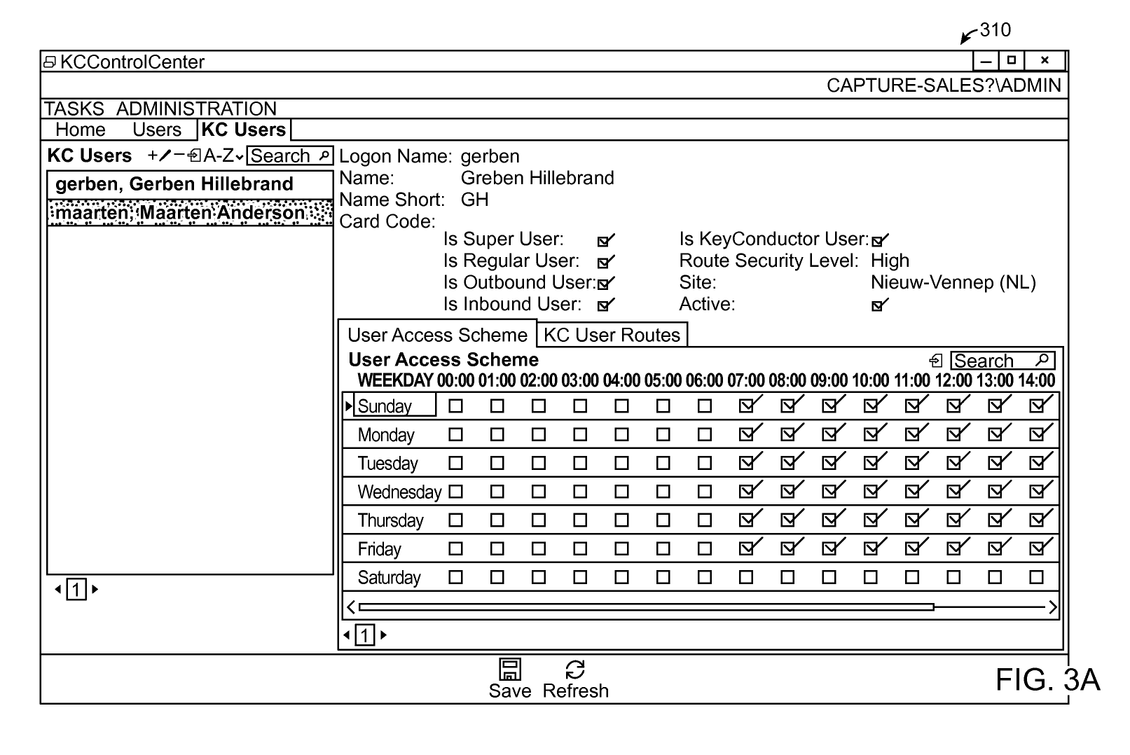

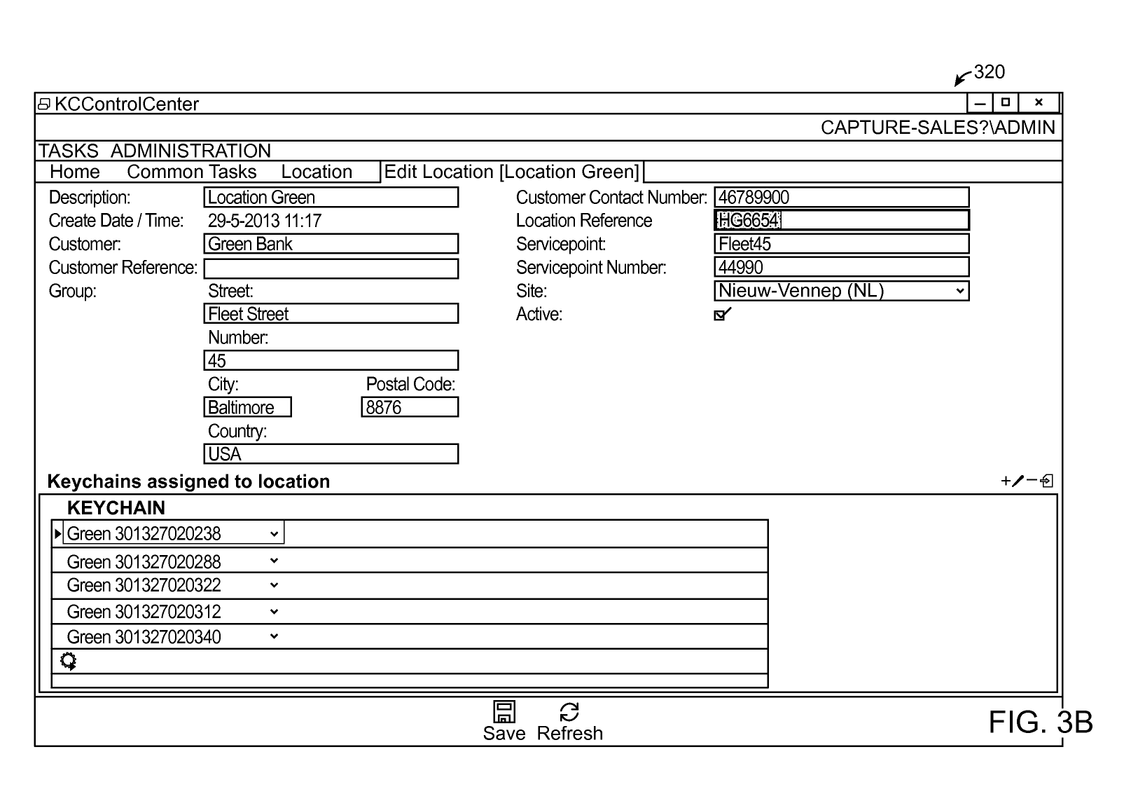

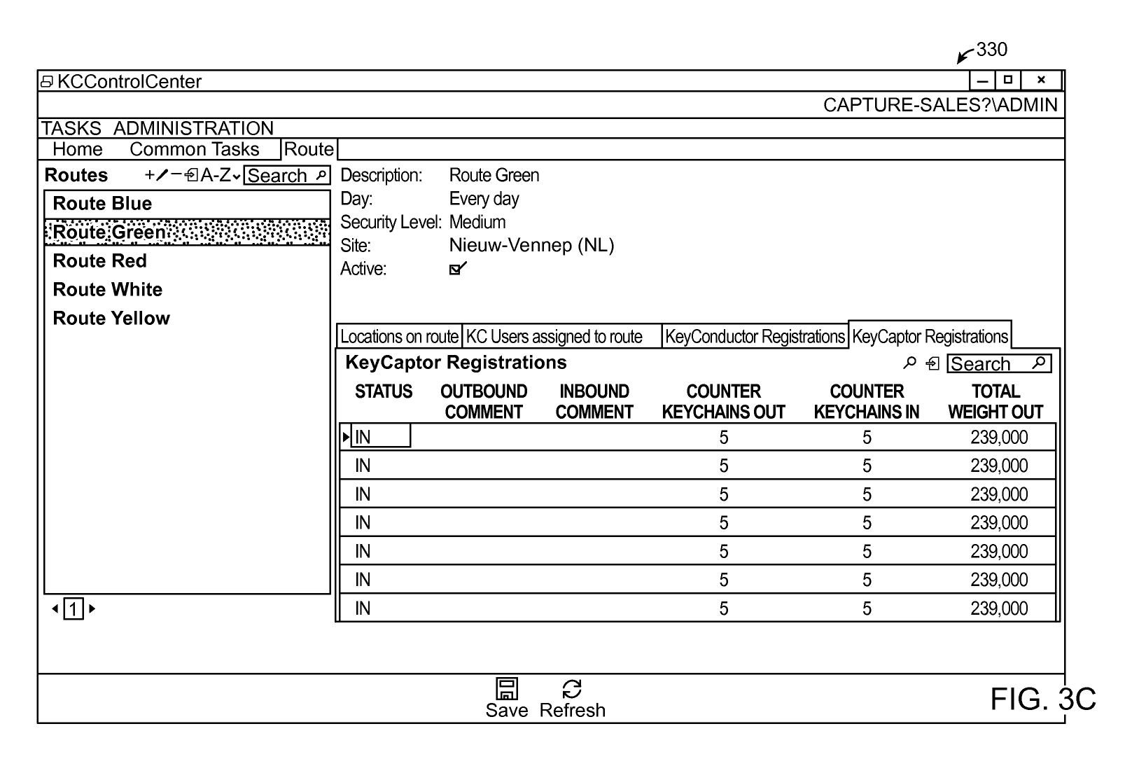

In some embodiments, the particular items to be weighed and identified are selected based on data provided through a user interface of a computing system (such as the computing system 140 illustrated in FIG. 1). For example, in some embodiments, keys may need to be provided to a particular user, for a particular destination or route, etc. Data identifying the user, the destination, etc., can thus be used to access a database to identify the keys that need to be provided to the particular user, or for the particular location/route. With reference to FIGS. 3A-C, example screenshots are shown of a graphical user interface (GUI) 310 through which information about users and user authorization is provided, a GUI 320 through which customer and location information (including the keys required for those customers and/or at those locations) is provided, and a GUI 330 through which route information (e.g., the locations to be visited by a particular user) is provided. Additional user interfaces for entering additional types of data required for tracking and managing traceable objects/assets can also be implemented. Once the keys (or other traceable objects) required by a particular user and/or for a particular location/route are identified, those keys are retrieved e.g., by an administrator manually collecting the required objects, or automatically by causing displays (e.g., lights, or other visual/audible/tactile displays) to be activated. The retrieved objects are then suspended from the suspension member of the weight measure device for further processing. In some embodiments, the route that a user needs to serve may be determined based on the keys (or other traceable objects) that are being checked out. Thus, if the detected identification information associated with the wireless identification devices coupled to the traceable objects that are to be checked-out are associated with a particular route (as can be determined based on the information from the database implemented on the computing system 140), appropriate notifications and/or other actions can be performed by the computing system 140.

The identification information received by the communication module and the measured weight information are provided to the computing system (such as the computing system 140 illustrated in FIG. 1). Based on the route/location information that may have been indicated earlier, the system can confirm that the identification information provided by the wireless identification devices placed in the housing matches the identification of the keys that are associated with the indicated route(s)/location(s). If there is a mismatch in the information (e.g., because a key is missing, or because a wrong key was retrieved) an appropriate alert can be issued.

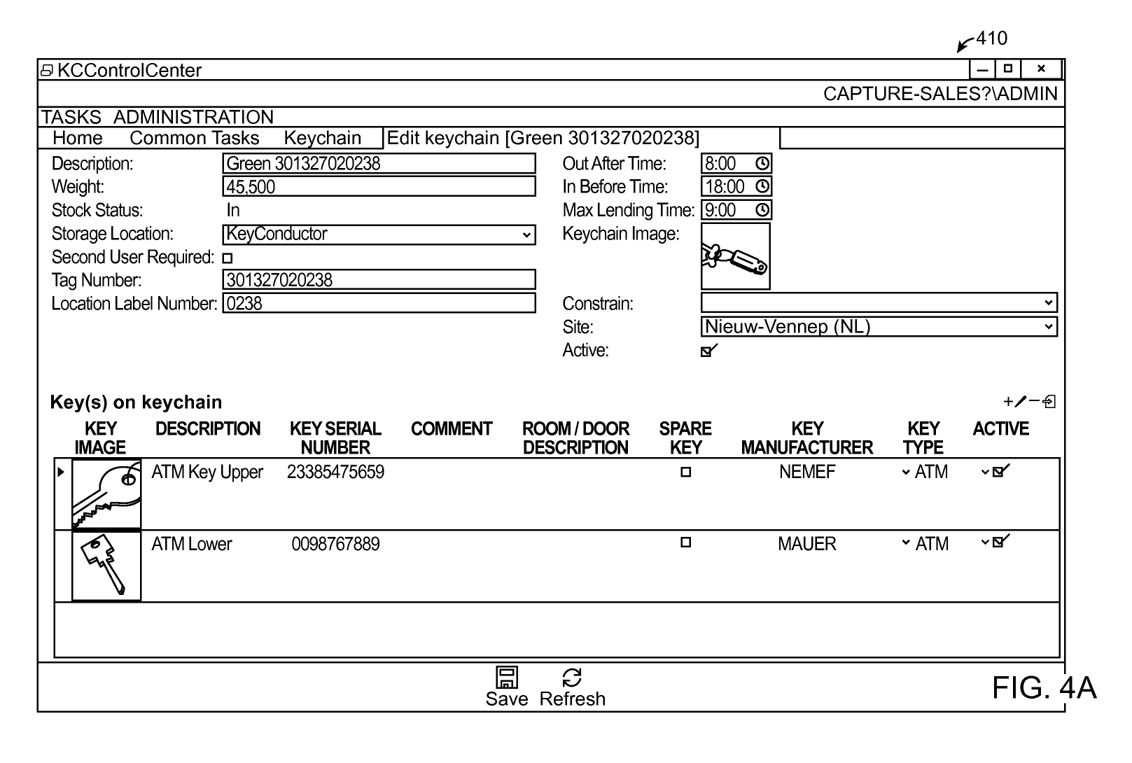

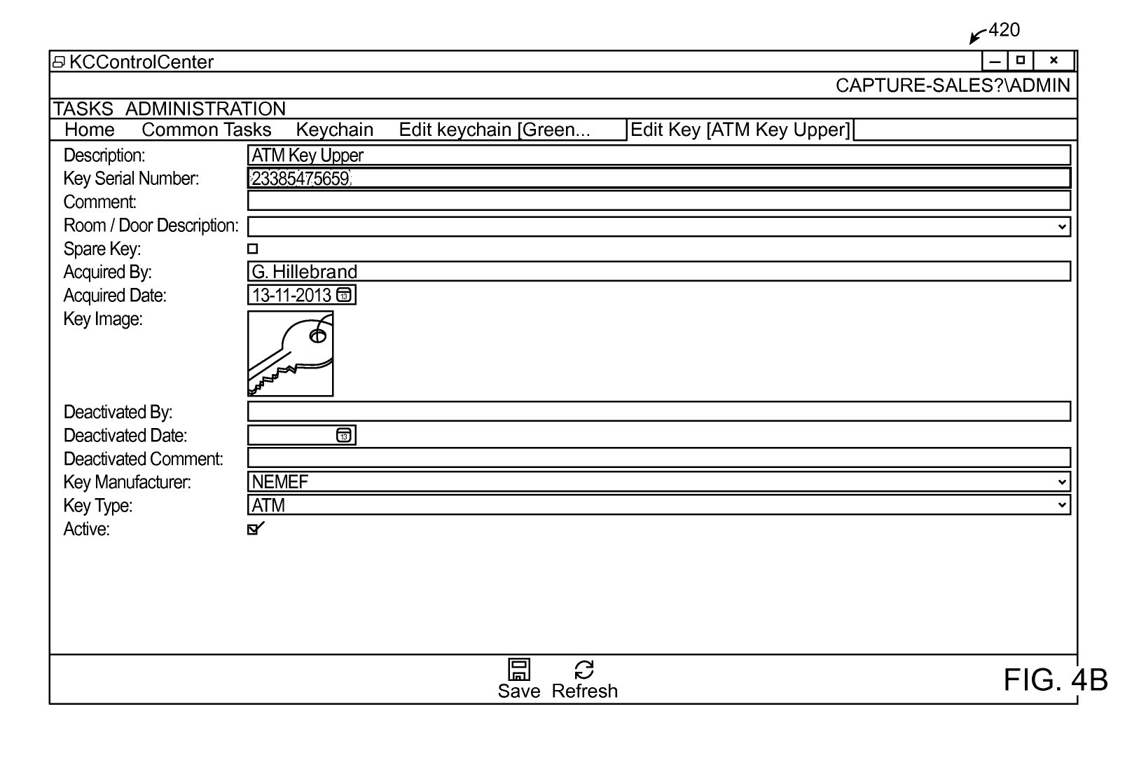

With continued reference to FIG. 2, based on the information transmitted by the respective wireless identification device of the each of the one or more items, individual weights for each of the one or more items suspended from the suspension member are obtained 230 from a database (e.g., a database implemented on a computing system such as the computing system 140). Such individual weight information may have been earlier provided via a GUI, such as GUI's 410 and 420 shown in FIGS. 4A and 4B, used for providing item information (or in this particular example, key information) such as weight of an item, weight of the wireless identification device attached to the item, threshold and restrictions information (e.g., how long an item may be checked out), and/or to provide audit trail information for individual items (e.g., record the history of information changes made in relation to the respective individual items).

Having obtained the pre-recorded individual weight of the individual items (e.g., items that each include the wireless identification device and the actual corresponding traceable object), a determination is made 240 whether the combined weight of the one or more items suspended from the suspension member of the weight measure device at the first time instance matches a sum of the individual weights, obtained from the database, for the one or more items. If there is a mismatch between the measured combined weight and the expected sum of the individual weights of the items selected, an appropriate alert can be issued. In some embodiments, an exact match between the measured combined weight and the expected combined weight is not required, as long as the two values are within some threshold value from each other (such threshold value being representative of the weight tolerance). Thus, in such embodiments, the difference between the measured combined weight and the expected combined weight needs to be less than or equal to some pre-determined weight tolerance value. In some embodiments, the pre-determined weight tolerance value can be adjusted/controlled based on input from an administrator (or someone else).

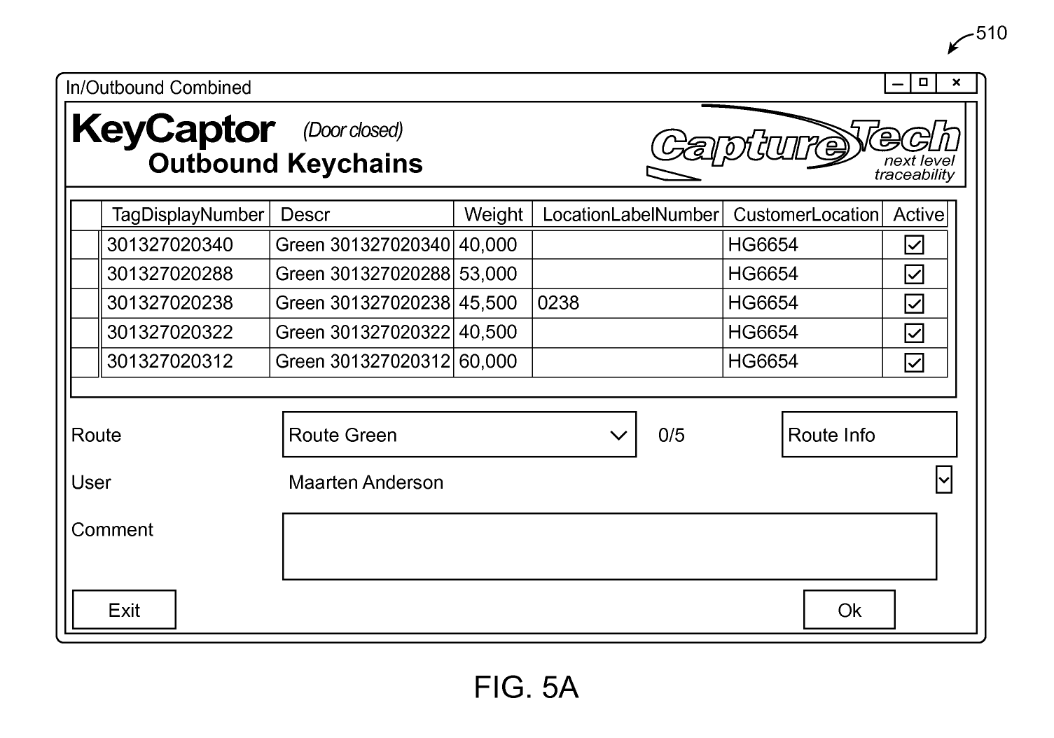

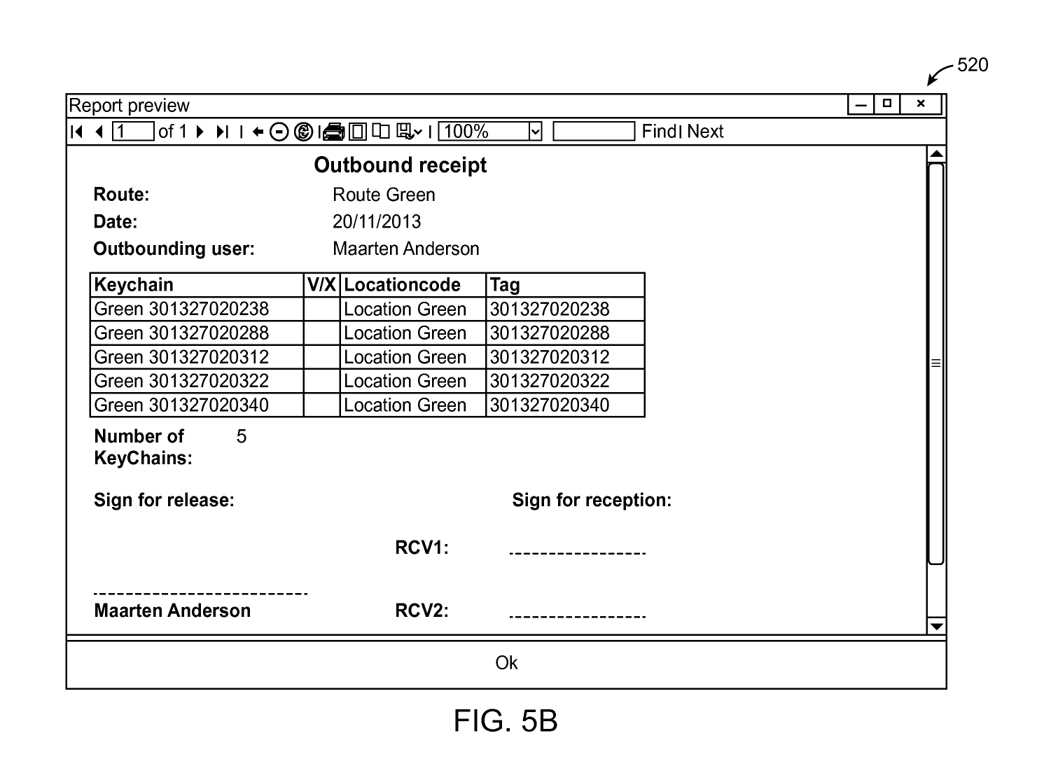

Once the selected items are weighed and identified, and no alert is issued, a transaction receipt confirming the issuance of the items can be generated and signed (physically or electronically) by the user receiving the items and/or the administrator overseeing the weighing and identification of the items transferred to the user. FIGS. 5A-B are example screenshots of an item-checkout summary 510 and an outbound receipt 520 to be signed or confirmed by the user taking possession of the items.

As noted, at the inbound (i.e., return/collection of the traceable objects) a similar procedure to that performed during check-out may be followed. Particularly, a determination may be made whether all the right wireless identification devices have been returned and that no wireless identification devices (e.g., KeyCop™ identification devices) are missing. If a certain key has been broken, the system will detect a weight discrepancy and some remedial action will be initiated (e.g., the user and/or the administrator will be asked to intervene).

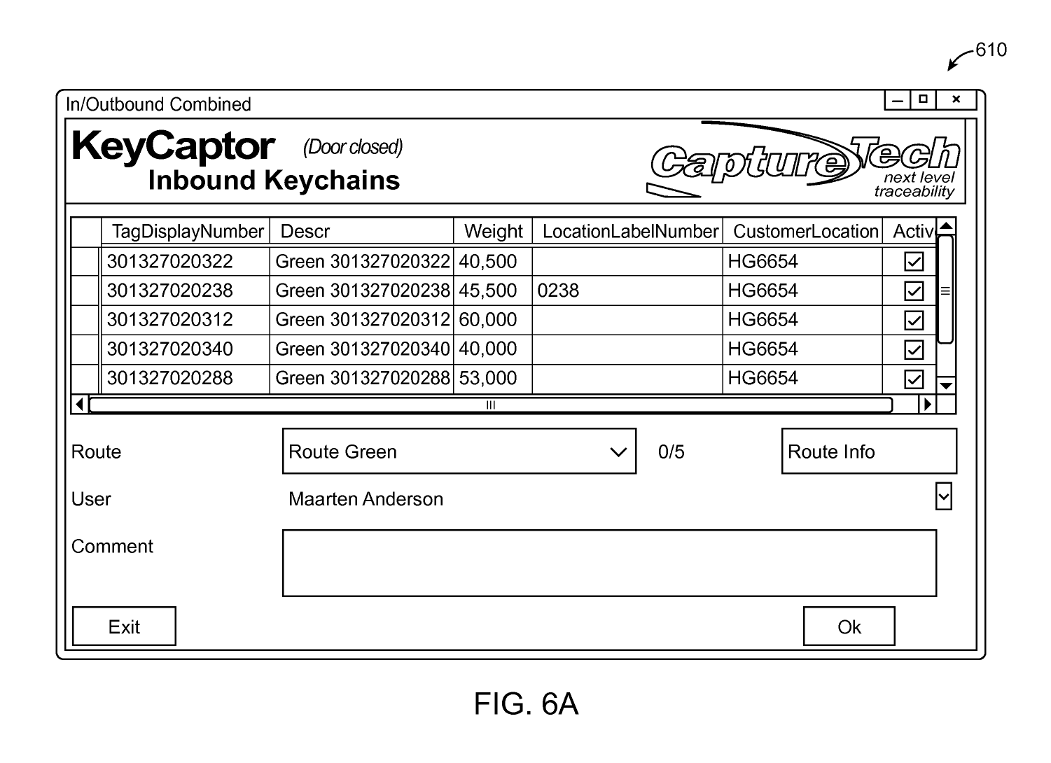

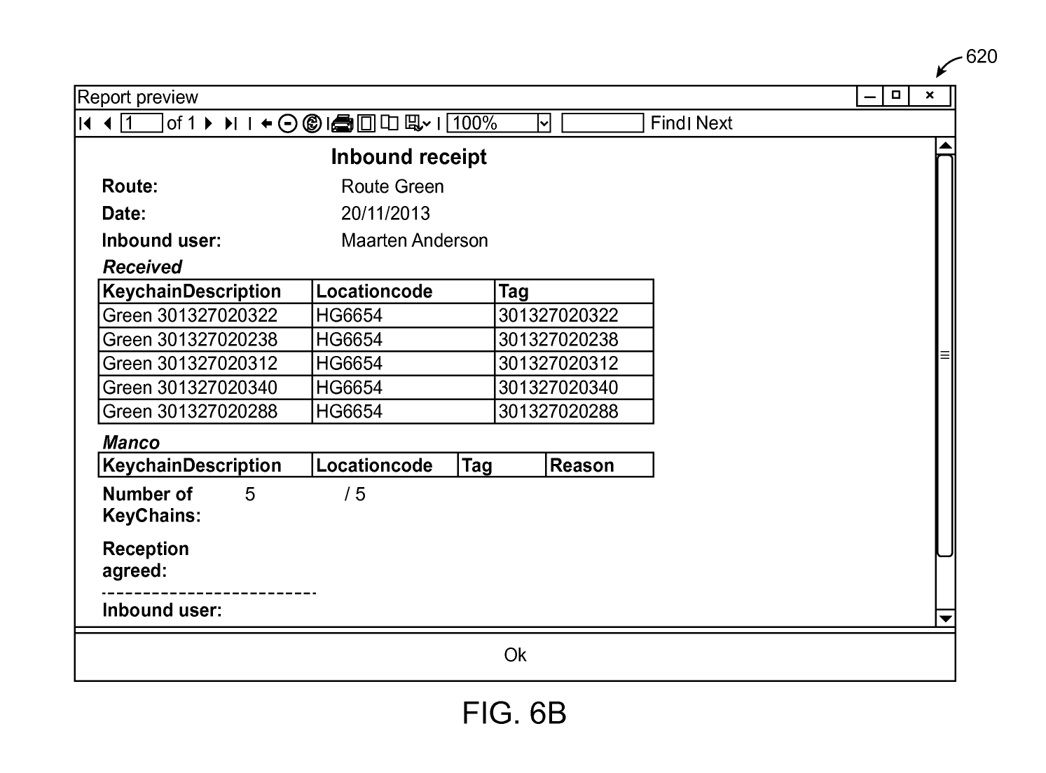

Thus, in such embodiments, at a second, subsequent, time instance (corresponding to the return time for the items previously checked out), weight of a returned set of items, suspended from the suspension member of the weight measure device, is measured. At substantially the same time, identification information transmitted from at least one returned wireless identification device included with the returned set of items is obtained (i.e., at substantially the second time instance). Based on the information transmitted by the at least one returned wireless identification device included with the returned set of items, individual weights for each returned item in the returned set of items suspended from the suspension member can be obtained from the database, and a determination made as to whether the combined weight of the returned set of items measured at the second time instance matches a sum of the individual weights obtained from the database of the each returned item in the returned set of items. In some embodiments, the item-return procedure does not require an exact match of the combined weight of the items returned with the expected sum of the individual weights of the returned items. Rather, some pre-determined weight tolerance (which may be the same or different than the tolerance used to verify that the measured combined weight of the items checked out substantially matches the expected weight sum for those items) is allowed. When there is no discrepancy in the measured weight of the returned items and the expected weight sum, an inbound receipt (or some other confirmation) is provided. FIG. 6A is an example screenshot 610 of an inbound item returned summary, and FIG. 6B is an example screenshot 620 of an inbound receipt. When a determination is made that there is a weight discrepancy, the user may be prompted (e.g., by the user interface of the computing system 140) to enter a reason for the discrepancy.

In some embodiments, having measured the weight of the returned item(s), and having obtained the identification information transmitted by the identification wireless device(s) of the returned item(s), a determination may be made whether the combined weight of the returned set of items measured at the second time instance matches the combined weight of the one or more items measured at the first time instance, and whether the identification information obtained from the at least one returned wireless identification device at the second time instance matches the information transmitted by the respective wireless identification device of the each of the one or more items obtained at the first time instance.

By using the methods, systems, and other implementations described herein in relation to tracking and managing traceable objects coupled to wireless identification devices, the average inbound and outbound processes can be performed significantly faster than performing a regular manual check-out and/or check-in processes (where all the individual seal numbers typically have to be checked one at a time). The systems, methods, and other implementations described herein are also more reliable than conventional manual procedures due to the fact that with only visual checks, traceable objects (e.g., keys) that have been broken are often not detected.

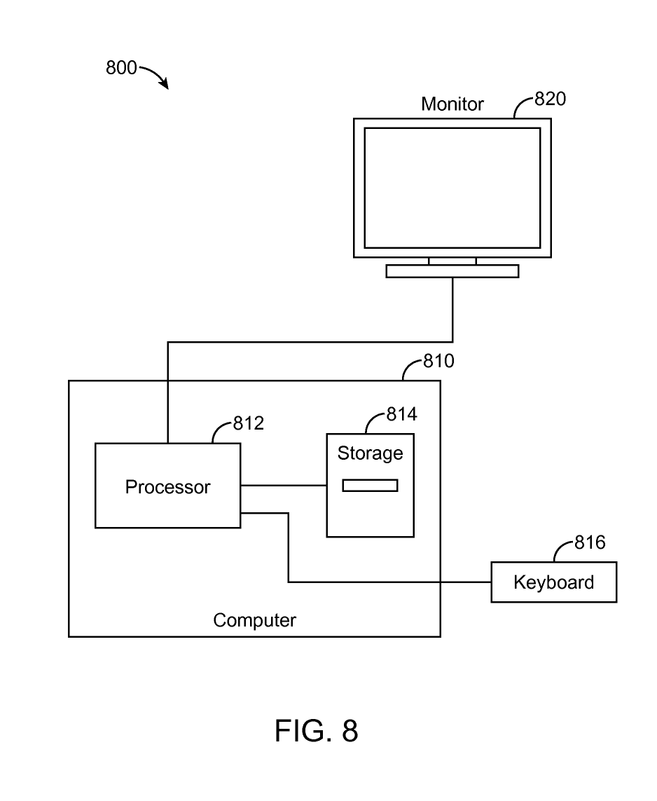

Performing the various operations described herein may be facilitated by a processor-based computing system. Particularly, at least part of at least some of the various systems/devices described herein (e.g., the computing system 140, the wireless identification devices, etc.) may be implemented using one or more processing-based devices. Thus, with reference to FIG. 8, a schematic diagram of a generic computing system 800 is shown. The computing system 800 includes a processor-based device 810 such as a personal computer, a specialized computing device, and so forth, that typically includes a central processor unit 812. In addition to the CPU 812, the system includes main memory, cache memory and bus interface circuits (not shown). The processor-based device 810 may include a mass storage element 814, such as a hard drive or flash drive associated with the computer system. The computing system 800 may further include a keyboard 816, or keypad, or some other user input interface, and a monitor 820, e.g., a CRT (cathode ray tube) or LCD (liquid crystal display) monitor, that may be placed where a user can access them.

The processor-based device 810 is configured to facilitate, for example, the implementation of operations to track and manage traceable objects coupled to wireless identification devices, including operations to obtain identification information and weight measurement information for checked-out items and/or returned items, and determine weight discrepancies between measured weights for checked-out and/or returned items and their expected weight sums. The storage device 814 may thus include a computer program product that when executed on the processor-based device 810 causes the processor-based device to perform operations to facilitate the implementation of the procedures described herein. The processor-based device may further include peripheral devices to enable input/output functionality. Such peripheral devices may include, for example, a CD-ROM drive and/or flash drive (e.g., a removable flash drive), or a network connection (e.g., implemented using a USB port and/or a wireless transceiver), for downloading related content to the connected system. Such peripheral devices may also be used for downloading software containing computer instructions to enable general operation of the respective systems/devices. Alternatively and/or additionally, in some embodiments, special purpose logic circuitry, e.g., an FPGA (field programmable gate array), an ASIC (application-specific integrated circuit), a DSP processor, etc., may be used in the implementation of the system 800. Other modules that may be included with the processor-based device 810 are speakers, a sound card, a pointing device, e.g., a mouse or a trackball, by which the user can provide input to the computing system 800. The processor-based device 810 may include an operating system, e.g., Windows XP® Microsoft Corporation operating system. Alternatively, other operating systems could be used.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

Some or all of the subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an embodiment of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server generally arises by virtue of computer programs running on the respective computers and having a client-server relationship to each other.

Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the embodiments and features disclosed herein. Other unclaimed embodiments and features are also contemplated. Accordingly, other embodiments are within the scope of the following claims.

What is claimed is:

1. A system comprising:
a weight measure device with a suspension member;
a wireless communication module; and
a controller configured to cause, when operating, operations comprising:
measuring a combined weight of one or more items suspended from the suspension member of the weight measure device at a first time instance, each of the one or more items including a respective traceable object coupled to a respective wireless identification device;
obtaining information transmitted to the wireless communication module by the respective wireless identification device of the each of the one or more items suspended from the suspension member of the weight measure device at the first time instance, the information representative of an identification associated with the respective wireless identification device and the respective traceable object;
obtaining from a database in electrical communication with the controller, based on the information transmitted by the respective wireless identification device of the each of the one or more items, individual weights for each of the one or more items suspended from the suspension member; and
determining whether the combined weight of the one or more items suspended from the suspension member of the weight measure device at the first time instance matches a sum of the individual weights obtained from the database for the one or more items.

2. The system of claim 1, wherein the controller is further configured to cause further operations comprising:
measuring weight of a returned set of items suspended from the suspension member of the weight measure device at a second time instance subsequent to the first time instance;
obtaining identification information transmitted from at least one returned wireless identification device included with the returned set of items suspended from the suspension member of the weight measure device at the second time instance;
obtaining from the database, based on the information transmitted by the at least one returned wireless identification device included with the returned set of items, individual weights for each returned item in the returned set of items suspended from the suspension member; and
determining whether the combined weight of the returned set of items measured at the second time instance matches a sum of the individual weights obtained from the database for the each returned item in the returned set of items.

3. The system of claim 2, wherein the controller is further configured to cause further operations comprising:
determining whether the combined weight of the returned set of items measured at the second time instance matches the combined weight of the one or more items measured at the first time instance, and whether the identification information obtained from the at least one returned wireless identification device at the second time instance matches the information transmitted by the respective wireless identification device of the each of the one or more items at the first time instance.

4. The system of claim 1, wherein the weight measure device and the wireless communication module are housed in a cabinet.

5. The system of claim 4, wherein the wireless communication module is housed in a detachable L-shaped cartridge that can be fitted into a cavity defined in an inner wall of the cabinet.

6. The system of claim 4, wherein the cabinet includes internal walls constructed from a radiation-impervious material to prevent transmission of wireless signals originating within the cabinet from exiting the cabinet.

7. The system claim 1, wherein the respective wireless identification device of the each of the one or more items comprises an RFID device.

8. The system claim 1, wherein the suspension member of the weight measure device comprises a hook.

9. The system claim 8, wherein the respective traceable object of the each of the one or more items comprises a key, and wherein one or more keys are configured to be suspended from the hook.

10. The system claim 1, further comprising a basket suspended from the suspension member, the basket configured to receive items for weight measurement and identification processing.

11. The system claim 1, wherein the respective traceable object of the each of the one or more items comprises one or more of: a key, a fire arm, ammunition, or a portable a communication device.

12. The system of claim 1, wherein the controller is further configured to cause further operations comprising:
controlling one or more of a data rate or transmission power of the communication control module.

13. The system of claim 1, determining whether the combined weight of the one or more items suspended from the suspension member of the weight measure device at the first time instance matches the sum of the individual weights obtained from the database for the one or more items comprises:
determining whether a difference between the combined weight of the one or more items suspended from the suspension member of the weight measure device at the first time instance and the sum of the individual weights obtained from the database for the one or more items is less than or equal to a pre-determined weight tolerance value.

14. The system of claim 13, wherein the controller is further configured to cause further operations comprising:
setting the pre-determined weight tolerance value based on input from a user.

15. The system of claim 1, wherein the controller is further configured to cause further operations comprising:
determining based on identification information obtained from one or more wireless identification devices whether one or more objects associated with the identification information obtained from the one or more wireless identification devices are to be checked-out or are being returned; and
identifying a route associated with the one or more objects.

16. A method comprising:
measuring a combined weight of one or more items suspended from a suspension member of a weight measure device at a first time instance, each of the one or more items including a respective traceable object coupled to a respective wireless identification device;
obtaining information transmitted to a wireless communication module by the respective wireless identification device of the each of the one or more items suspended from the suspension member of the weight measure device at the first time instance, the information representative of an identification associated with the respective wireless identification device and the respective traceable object;
obtaining from a database, based on the information transmitted by the respective wireless identification device of the each of the one or more items, individual weights for each of the one or more items suspended from the suspension member; and
determining whether the combined weight of the one or more items suspended from the suspension member of the weight measure device at the first time instance matches a sum of the individual weights obtained from the database for the one or more items.

17. The method of claim 16, further comprising:
measuring weight of a returned set of items suspended from the suspension member of the weight measure device at a second time instance subsequent to the first time instance;
obtaining identification information transmitted from at least one returned wireless identification device included with the returned set of items suspended from the suspension member of the weight measure device at the second time instance;
obtaining from the database, based on the information transmitted by the at least one returned wireless identification device included with the returned set of items, individual weights for each returned item in the returned set of items suspended from the suspension member; and
determining whether the combined weight of the returned set of items measured at the second time instance matches a sum of the individual weights obtained from the database for the each returned item in the returned set of items.

18. The method of claim 17, further comprising:
determining whether the combined weight of the returned set of items measured at the second time instance matches the combined weight of the one or more items measured at the first time instance, and whether the identification information obtained from the at least one returned wireless identification device at the second time instance matches the information transmitted by the respective wireless identification device of the each of the one or more items at the first time instance.

19. The method of claim 16, wherein the respective wireless identification device of the each of the one or more items comprises an RFID device.

20. The method of claim 16, wherein the respective traceable object of the each of the one or more items comprises one or more of: a key, a fire arm, ammunition, or a portable a communication device.

21. An apparatus comprising:
means for measuring a combined weight of one or more items suspended from a suspension member of a weight measure device at a first time instance, each of the one or more items including a respective traceable object coupled to a respective wireless identification device;
means for obtaining information transmitted to a wireless communication module by the respective wireless identification device of the each of the one or more items suspended from the suspension member of the weight measure device at the first time instance, the information representative of an identification associated with the respective wireless identification device and the respective traceable object;
means for obtaining from a database, based on the information transmitted by the respective wireless identification device of the each of the one or more items, individual weights for each of the one or more items suspended from the suspension member; and
means for determining whether the combined weight of the one or more items suspended from the suspension member of the weight measure device at the first time instance matches a sum of the individual weights obtained from the database for the one or more items.

22. A non-transitory computer readable media programmed with a set of instructions executable on a processor that, when executed, causes operations comprising:
measuring a combined weight of one or more items suspended from a suspension member of a weight measure device at a first time instance, each of the one or more items including a respective traceable object coupled to a respective wireless identification device;
obtaining information transmitted to a wireless communication module by the respective wireless identification device of the each of the one or more items suspended from the suspension member of the weight measure device at the first time instance, the information representative of an identification associated with the respective wireless identification device and the respective traceable object;
obtaining from a database, based on the information transmitted by the respective wireless identification device of the each of the one or more items, individual weights for each of the one or more items suspended from the suspension member; and
determining whether the combined weight of the one or more items suspended from the suspension member of the weight measure device at the first time instance matches a sum of the individual weights obtained from the database for the one or more items.
